(19) United States
(12) Patent Application Publication
(10) Pub. No.: US 2018/0067750 A1
(43) Pub. Date: Mar. 8, 2018

(54) Method and Device (Universal Multifunction Accelerator) for Accelerating Computations by Parallel Computations of Middle Stratum Operations

(71) Applicant: Venu KANDADAI, Hyderabad (IN)

(72) Inventor: Venu KANDADAI, Hyderabad (IN)

(21) Appl. No.: 15/806,598

(22) Filed: Nov. 8, 2017

Related U.S. Application Data
(63) Continuation of application No. 13/596,269, filed on Aug. 28, 2012.

(30) Foreign Application Priority Data
May 19, 2012 (IN) 1989/CHE/2012

(51) Int. Cl. G06F 9/38; G06F 9/345

(52) U.S. Cl. CPC G06F 9/3877; G06F 9/345

(57) ABSTRACT

This invention constitutes a method and apparatus for enabling parallel computations of intermediate operations which are generic in many algorithms in given applications and also contain most of the computationally intensive operations. The method includes designing a set of intermediate level functions suitable for predefined application, obtaining instructions corresponding to intermediate level operations from a processor, computing the addresses of the operands and the results, performing computations involved in multiple intermediate level operations. In an exemplary embodiment the apparatus consists of a local data address generator that computes the addresses of a plurality of operands and results, a programmable computational unit that performs parallels computations of the intermediate level operations and a local memory interface that is interfaced to local memory organized in multiple blocks. The local data address generator and programmable computational unit are configurable to cover any field requiring large computations.

### CROSS-REFERENCE TO RELATED APPLICATIONS

The present application is a continuation application of U.S. patent application Ser. No. 13/596,269, entitled “Method and Device (Universal Multifunction Accelerator) for Accelerating Computations by Parallel Computations of Middle Stratum Operations”, filed on Aug. 28, 2012, now U.S. Publication No. US 2013/0311753 A1, published on Nov. 21, 2013, which claims priority to and the benefit of the following co-pending India non-provisional patent application entitled “Method and Device (Universal Multifunction Accelerator) for Accelerating Computations by Parallel Computations of Middle Stratum Operations”, Serial No.: 1989/CHE/2012, Filed: May 19, 2012, the disclosures of which are incorporated in their entirety herewith to the extent not inconsistent with the disclosure herein.

### TECHNICAL FIELD OF INVENTION

The method and device designed in this invention relates generally to the field of high performance computing and specifically to accelerating different applications using hardware accelerators. This invention particularly pertains to designing architecture for integrated circuits using parallel computing of operations specifically designed for different applications.

### BACKGROUND OF THE INVENTION

There is an ever increasing need for high performance computing. Often, the requirement of high computational ability is also coupled with the competing demand of low power consumption. For example multimedia computation is one such case where the requirements are towards high resolution and high definition applications on devices most of which operate on batteries. There are stringent power and performance requirements for such devices. There are a number of techniques used to increase the computational power while attempting to consume less energy.

Design of high performance processors (RISC and DSP processors), extensions to processors such as Single Instruction Multiple Data (SIMD), Multiple Instruction Multiple Data (MIMD), coprocessors and so on, are the existing modifications to the processors to achieve better computing abilities. Processors with performance oriented architectures like multi-issue, VLIW (Very Long Instruction Word) or more general super scalar architectures were also tried, though with much less success due to their large circuit size and power consumptions.

SIMD and MIMD type of extensions to the processor architecture try to perform multiple operations in a single processor cycle to achieve higher computational speed. Suitably designed register set is used to provide operands for the multiple operations and to store the results of those operations.

SIMD and similar extensions to processors require organization of the data in a specific manner and hence provide advantage only in situations where such organization of data is readily available without needing a prior step of rearrangement. Further, since SIMD technique involves only basic mathematical operations, SIMD cannot be used in the parts of the algorithms where sequential order of computations at basic mathematics level is required. Thus these type of extensions provide limited acceleration of computations, with best case providing at most 40% reductions in cycles required for computation of a complete algorithm like video decoding. Thus these types of extensions yield much less power advantage owing the additional circuitry required.

There are other innovative approaches adopted to achieve high performance such as vector processing engines, configurable accelerators and so on. Work on reconfigurable array processors for floating point operations [N11], adaptable arithmetic node [N2] and a configurable arithmetic unit [E4] were attempts to achieve efficiency in performing mathematical operations using vector processing and configurability.

The methods to achieve higher computational power described above are all aimed at carrying out basic mathematical operations more efficiently. DSP processors perform operations, such as multiply and accumulate (MAC), which are a step above basic mathematical operations. Though these are general basic operations occur in various algorithms of different applications, the speeding up at this level of basic operations can provide limited acceleration in computations for the reasons stated above.

Multi-core architectures, on the other hand, are extensively used to speed up computations. These architectures are used in personal computers, laptop computers and tablet computers and even in higher end mobile phones. Elaborate power management schemes are used to minimize power consumption due to multiple cores.

Multi-core architectures achieve higher computational capability through parallel processing of the algorithms. Therefore the algorithm should be amenable for parallel processing (multi threading), for a multi-core architecture to be effective. Consequently the acceleration of computations achievable in multi-core processors is also limited in addition to the higher power consumption due to the presence of multi-cores.

A different approach that is used to speedup computations is to build circuits (hardware accelerator) that implement whole algorithm or a part of it that require heavy computations. Hardware accelerators are normally designed to accelerate the most computationally expensive part of an algorithm (Fourier transform in audio codecs, de-blocking filter in video codecs etc.). Sometimes hardware accelerators are built for a complete algorithm like video decoder. This approach provides very good acceleration of the algorithm. The power requirements are also minimal in this case since the circuit is specifically designed for given computations.

However any change in the flow of computations makes the existing hardware accelerator unusable and requires construction of a new circuit. There are some configurable hardware accelerators, but the extent to which they are configurable is normally for a few modes or a few closely related algorithms.

Using hardware accelerators to accelerate just a part of the algorithm partially overcomes the above mentioned problem because the flow of the part that is not in hardware accelerator (and hence running on the general purpose processor) can be modified. However this approach requires several hardware accelerators to achieve meaningful performance improvement over the whole algorithm and still leaves parts of the algorithm un-accelerated, thereby limiting overall performance.

To sum up, current state-of-the-art in achieving high performance computing—namely high rate of computing with low power consumption—can be categorized into three types: (A) parallel computation of basic mathematical operations using vector processing, super scalar architectures, (B) parallel/multi-core processors, and (C) dedicated circuits to compute whole or part of the algorithms. Type-A techniques yield limited acceleration, mainly because of the limited extent to which basic operations can be parallelized in algorithms. Type-B techniques also yield limited acceleration mainly due to the extent to which the algorithms can be multi-threaded. Type-C techniques yield good acceleration, but have extremely limited flexibility.

This invention seeks to remove the above discussed limitations by proposing a different level of accelerating the computations which are above the level of basic operations but below whole algorithm and a generic part that contains most of the computationally intensive part but common in several algorithms (Middle Stratum operations are Intermediate level operations).

### BRIEF SUMMARY OF THE INVENTION

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A more complete appreciation of the present invention and the scope thereof can be obtained from the accompanying drawings which are briefly summarized below and the following detailed description of the presently preferred embodiments.

A method and an apparatus (Universal Multifunction Accelerator) for enabling a parallel computation of middle stratum operations in multiple applications in a computational system are disclosed.

An exemplary embodiment of the present invention is to enable parallel computations to accelerate plurality of applications such as multimedia, communications, graphics, data security, financial, other engineering and scientific and general computing.

An exemplary embodiment of the present invention is to support optimally designed instructions for accelerating different applications. The optimally designed instructions are at a level above basic mathematical operations and preserve a sufficient generality to be algorithm independent (intermediate level or middle stratum operations).

An exemplary embodiment of the present invention is to support a plurality of digital signal processor instructions for multimedia applications.

An exemplary objective of the present invention is to achieve high performance computations in different types of computations by accelerating the intermediate operations.

According to a non limiting exemplary aspect of the present invention, the universal multi functional accelerator, accelerates various computations of Fourier transform operations such as radix-2, radix-4 and the like.

In accordance with a non limiting exemplary aspect, the choice of operations such of radix-2 allows this method to be algorithm independent.

An exemplary embodiment of the present invention is to provide a plurality of instructions to accelerate a plurality of data security algorithms such as hashing, encryption, decryption and the like.

An exemplary embodiment of the present invention is to support corresponding instructions to cover the different applications.

In accordance with a non limiting exemplary aspect, the universal multi functional accelerator provides high acceleration of computations by performing a plurality of mathematical operations in one processor cycle on a set of data present in the local memory of universal multifunction accelerator.

According to a first aspect of the present invention, the method includes transferring an instruction to an instruction decoder, whereby the instruction decoder performs a decoding operation of the instruction and transfers a plurality of required control signals to a local data address generator. The method further includes a step of receiving the instruction from a processor.

According to the first aspect, the method includes transferring the initial address of plurality of operands needed for the operation to be performed and transferring the initial destination address of the results to a local data address generator.

According to the first aspect, the method includes determining a source address and a destination address of data through the local data address generator, whereby the local data address generator computes an addresses corresponding to a location of a plurality of data points required for performing a computational operation of the instruction and the addresses of the locations where plurality of results are to be stored.

According to the first aspect, the method includes performing a plurality of computational operations specified by the instruction in a programmable computational unit, whereby the plurality of computational operations comprises a predefined set of a combination of basic mathematical operations and basic logical operations.

According to the first aspect, the method includes accessing the plurality of data points by a local memory interface from a plurality of memory blocks, wherein addresses corresponding to a location of the plurality of data points are generated by a programmable local data address generator.

According to the first aspect, the method includes enabling a visualization of a plurality of memory blocks as a single memory unit to the computational system in a system memory interface, whereby the system memory interface enables use of standard data transfer operations and direct memory access transfer operations.

According to the first aspect, the method includes converting the system address received from the system bus to the local address by a system data address generator.

According to the first aspect, the method further includes a step of interfacing the universal multifunction accelerator with a tightly coupled memory port or a closely coupled memory port of the host processor.

According to the first aspect, the method further includes a step of including an operation code in an instruction for performing computational operations.

According to the first aspect, the method further includes a step of interfacing the plurality of memory blocks with a local memory interface to access the plurality of data points.

According to the first aspect, the method further includes a step of performing plurality of computational operations based on the instruction.

According to the first aspect, the method further includes a step of including a configuration parameter in the instruction to configure a universal multi function accelerator.

According to the first aspect, the method further includes a step of computing the address of multiple operands and results based on the configuration parameters.

According to the first aspect, the method further includes a step of performing plurality of computational operations based on the configuration parameters.

According to a second aspect of the present invention, the universal multifunction accelerator includes a programmable local data address generator configured to determine a source address and a destination address of an instruction.

According to the second aspect of the present invention, the universal multifunction accelerator includes a programmable computational unit for performing a plurality of computational operations specified in the instruction, whereby the plurality of computational operations comprising a predefined set of a combination of basic mathematical operation and basic logical operation.

According to the second aspect of the present invention, the universal multifunction accelerator includes a local memory interface for facilitating a step of accessing a plurality of data points from a plurality of memory blocks required for computing the instruction, whereby an address corresponding to a location of the plurality of data points is generated by the programmable local data address generator. The local memory unit comprising the plurality of memory blocks is interfaced to the local memory interface. The local memory interface supplies a plurality of operands to the programmable computation unit.

According to the second aspect of the present invention, the universal multifunction accelerator includes a system memory interface. A system bus communicates between the system memory interface and the computational system.

According to the second aspect of the present invention, the universal multifunction accelerator includes a system data address generator configured to translate a system address received form a system bus to a local memory address. The system data address generator enables visualization of a plurality of local memory blocks as a single memory unit to the computational system.

According to the second aspect of the present invention, the universal multifunction accelerator is further configured to accelerate a plurality of intermediate operations in the instruction.

According to the second aspect of the present invention, the universal multifunction accelerator further includes an instruction decoder to decode instructions from the host processor. The instruction decoder further configured to transmit a plurality of control signals to the local data address generator.

According to the second aspect of the present invention, the universal multifunction accelerator further includes a processor interface for interfacing a tightly coupled memory port of the host processor. The processor interface further interfaces with a closely coupled memory port of the host processor.

### BRIEF DESCRIPTION OF THE DRAWINGS

FIG. 1 is a diagram depicting a prior art system for computing basic mathematical operations using a processor.

FIG. 2 is a diagram depicting a prior art system for accelerating the computations of an algorithm by building a dedicated circuit (hardware accelerator).

FIG. 3 is a diagram depicting an overview of a system involving universal multifunction accelerator.

FIG. 4 is a diagram depicting an exemplary embodiment of performing parallel computation of two middle stratum operations of radix-2.

FIG. 5 is a diagram depicting an overview of universal multifunction accelerator together with local memory.

FIG. 6 is a diagram depicting an instruction structure in universal multifunction accelerator.

FIG. 7 is a diagram depicting an overview of connectivity between universal multifunction accelerator and local memory.

FIG. 8 is a diagram depicting an overview of connectivity between local data address generator and local memory interface of universal multifunction accelerator.

FIG. 9 is a diagram depicting an overview of connectivity between programmable computational unit and local memory interface of universal multifunction accelerator.

FIG. 10 is a diagram depicting an overview of connectivity between system data address generator and system memory interface with local memory interface of universal multifunction accelerator.

FIG. 11 is a diagram depicting an overview of connectivity between instruction decoder and a local data address generator of universal multifunction accelerator.

FIG. 12 is a diagram depicting an overview of connectivity between instruction decoder and a programmable computation unit of universal multifunction accelerator.

### DETAIL DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

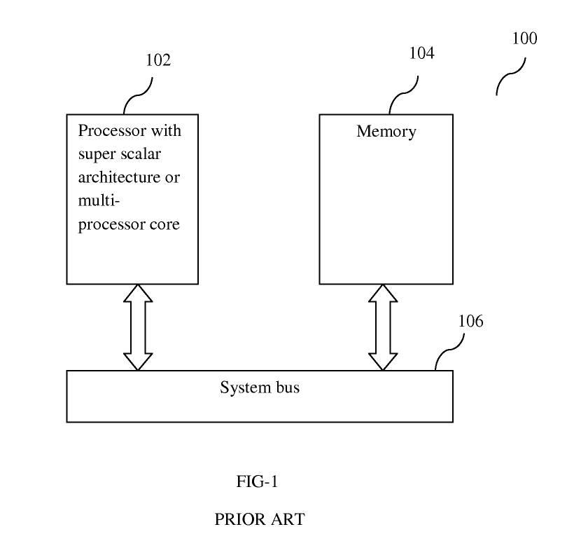

Referring to FIG. 1 is a diagram 100 depicting a prior art system for computing basic mathematical operations. The system includes a processor core (typically a multi-core processor) 102, memory 104 connected to a system bus 106 to transmit the data or instructions for performing basic mathematical operations. The processor core 102 is connected to a system bus 106 for transmitting the computed mathematical operations such as addition, subtraction, multiplications and the like to the memory 104. The processor core 102 and memory 104 uses a two way communication process with the system bus 106 to transmit and receive the data.

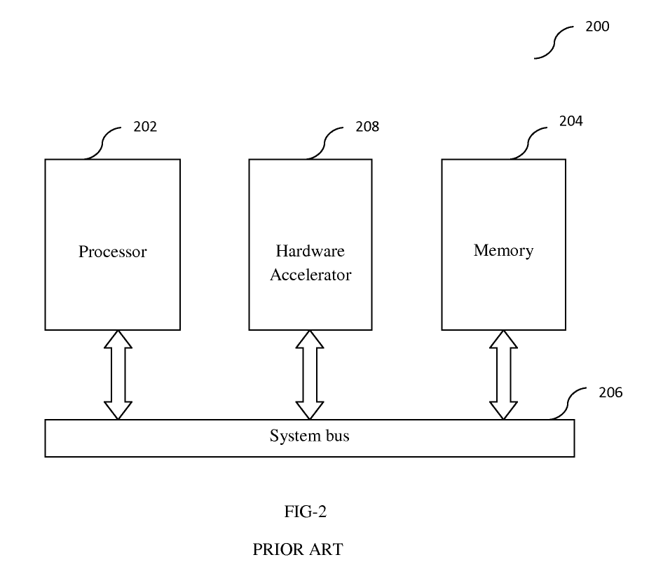

Referring to FIG. 2 is a diagram 200 depicting a prior art of the system for accelerating an algorithm by building a dedicated circuit (hardware accelerator). The system includes a processor 202, a memory 204 and a hardware accelerator 208 connected to a system bus 206 for accelerating the complete algorithm to perform specific computations.

The processor 202 connected to a system bus 206 controls the hardware accelerator 208. The hardware accelerator 208 is normally designed to compute a specific algorithm or the computationally expensive part of an algorithm. The memory 204 stores the data to be computed or already computed.

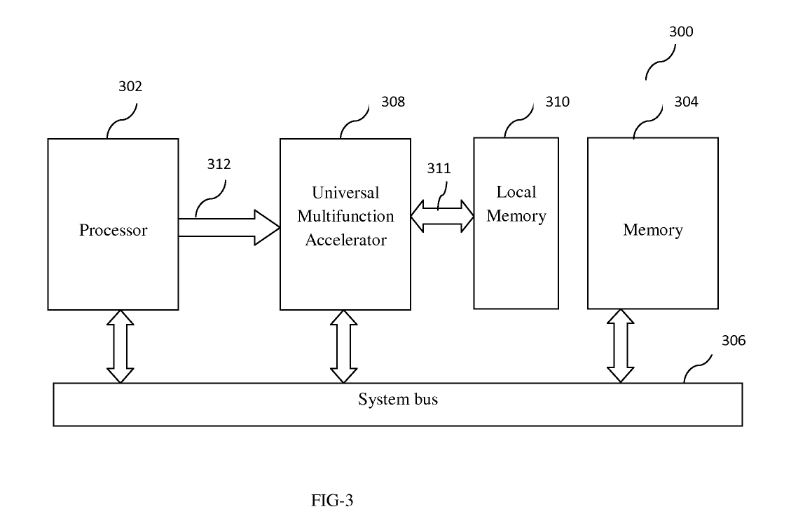

Referring to FIG. 3 is a diagram 300 depicting an overview of a computational system using universal multifunction accelerator. According to a non limiting exemplary embodiment of the present subject matter, the system includes a processor 302, a memory 304 and a universal multifunction accelerator 308 connected to a system bus 306 and a local memory 310. The universal multifunction accelerator 308 receives the instructions corresponding to the intermediate level operations to be performed from the processor through a connection 312.

In accordance with a non limiting exemplary implementation of the present subject matter, the processor 302 connected to a system bus 306 transmits the instructions to the universal multifunction accelerator 308 using the interconnection 312 to perform the predefined middle stratum operations on the data stored in the local memory 310. The local memory 312 is connected to the universal multifunction accelerator 308 through a dedicated interface 314.

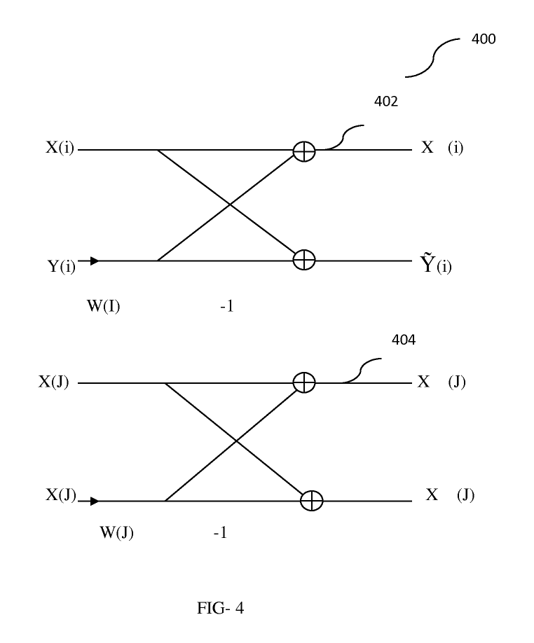

Referring to FIG. 4 is a diagram 400 depicting a non limiting exemplary intermediate operation of Radix-2 computation. The diagram 400 depicts two Radix-2 operations 402 and 404. According to a non limiting exemplary embodiment of the present subject matter, the process describes a parallel computation of two Radix-2 operations 402 and 404.

In accordance with a non limiting exemplary implementation of the present subject matter, the parallel computation of operations such as radix-2, radix-4 and the like are supported by universal multifunction accelerator. Such instructions are useful in accelerating Fourier transform, inverse Fourier transforms of any size and the variations thereof.

In accordance with a non limiting exemplary implementation of the present subject matter, a plurality of middle stratum operations, such as FIR filter, radix operations, windowing functions, quantization and the like, are designed and implemented in the universal multifunction accelerator to accelerate all multimedia applications.

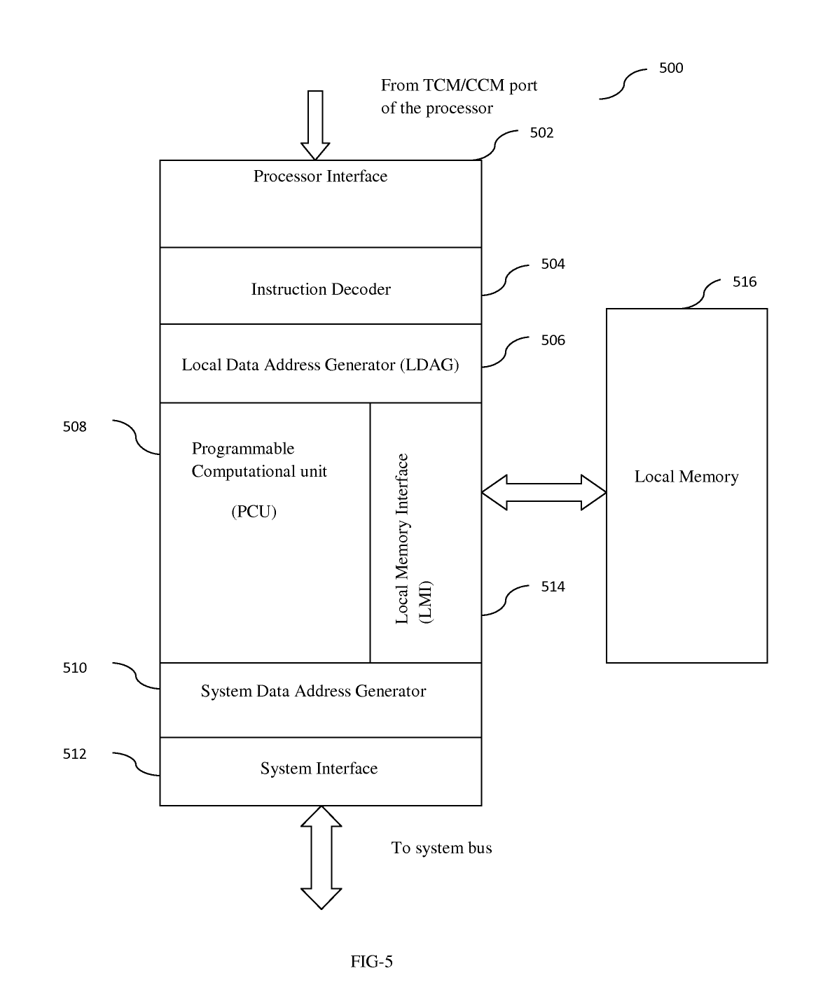

Referring to FIG. 5 is a diagram 500 depicting an overview of universal multi function accelerator. According to a non limiting exemplary embodiment of the present subject matter, the universal multifunction accelerator includes a processor interface 502, an instruction decoder 504, a local data address generator 506, a programmable computational unit 508, a system data address generator 510 and a system interface 512, local memory interface 514 connected to a local memory 516.

According to a non limiting exemplary embodiment of the present subject matter, the instructions are so designed as to includes the information to perform middle stratum operations that are a combination of both mathematical and logical operations required to accelerate different algorithms of a predefined application. The instruction designed also includes an initial address of operands, initial address of the destination ofthe results and the mode or configuration parameters. So the addresses of the multiple operands are determined based on the initial address of the operands embedded in the instruction and the multiple operands obtained based on these addresses performs the multiple operations specified by the middle stratum functions based on the information embedded in the instruction. Similarly the destination addresses of multiple results are determined based on the initial destination address of the results embedded in the instruction and transfers the results these address locations.

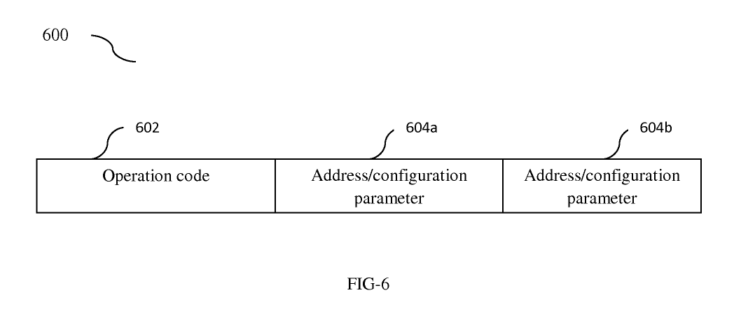

Referring to FIG. 6 is a diagram 600 depicting about an instruction structure in universal multifunction accelerator. According to a non limiting exemplary embodiment of the present subject matter, the instruction includes an operation code 602 and two address or configuration parameters 604a and 604b. The operation code 602 specifies the type of the intermediate level operation to be performed. The other two fields 604a and 604b of the instruction may contain two addresses in one non limiting exemplary embodiment. The two addresses may be the initial addresses of two operands or one operand and one result. One or both of the two fields 604a and 604b may contain configuration parameters in another non limiting exemplary embodiment.

In accordance with a non limiting exemplary implementation of the present subject matter, referring to FIG. 5 the processor interface 502 receives predesigned instructions of a particular application from tightly coupled memory or closely coupled memory port of the processor and transfers them to the instruction decoder 504. The instruction decoder 504 decodes the instructions received from the processor interface 502 and generates a necessary control signals and transfers them to different parts of the universal multifunction accelerator 500 such as local data address generator 506 and the programmable computational unit 508. The local data address generator 506 in the universal multifunction accelerator 500 determines the source and destination addresses of the multiple data points required for performing the operations of given instruction and the results.

According to a non limiting exemplary embodiment of the present subject matter, the programmable computational unit 508 of the universal multifunction accelerator 500 performs parallel computations of the intermediate operations such as two Radix-2 operations 400 depicted in FIG. 4 on the multiple data obtained from the local memory 516. The programmable computational unit 508 receives control signals from instruction decoder 504 for each operation supported by the universal multifunction accelerator 500 and performs arithmetic and logical operations on multiple data points to produce multiple results by suitably choosing the combinations of basic mathematical and logical operations as specified by the control signal.

According to a non limiting exemplary embodiment of the present subject matter, the system data address generator 510 of the universal multifunction accelerator 500 translates the system address to the address of the location of the data in the local memory 516. The local memory interface 514 in the universal multifunction accelerator 500 accesses the multiple data points for each of the plurality of instructions whose addresses are computed by the local data address generator 506 from a set of memory blocks configured in the local memory 516. The universal multifunction accelerator is also further configured with a system interface 512 where all the local memory blocks are visible as a single memory unit to the system such that load or store or perform direct memory access transfer operations are adequate to transfer data into and out of the local memory 516.

In a non limiting exemplary embodiment the local memory 516 of a size 16 kb is interfaced to a universal multifunction accelerator 500 and is further organized into several blocks of 1 kb each.

According to a non limiting exemplary embodiment of the present subject matter, the initial data on which requisite operations are to be performed are transferred to the local memory 516 of universal multifunction accelerator. While the local memory interface 514 configures the local memory 516 as several blocks of memory supplying multiple operands to programmable computational unit 508, the system memory interface makes the local memory 516 to appear as a single memory block to the computational system.

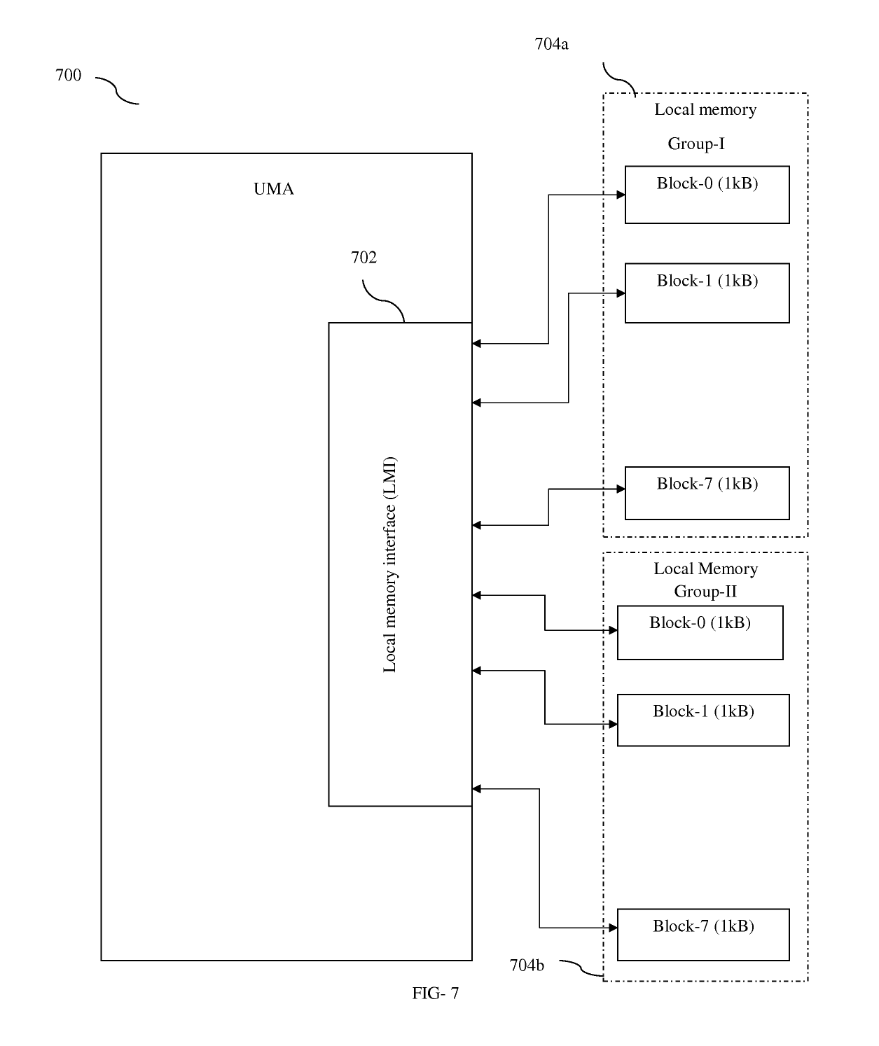

Referring to FIG. 7 is a diagram 700 depicting an overview of connectivity between universal multifunction accelerator and a local memory. According to a non limiting exemplary embodiment of the present subject matter, the system includes a local memory interface 702 of a universal multifunction accelerator interfaced to each group of the memory blocks 704a and 704b.

In accordance with a non limiting exemplary implementation of the present subject matter, the local memory interface 702 configured in the universal multifunction accelerator accesses multiple operands from a group of plurality of blocks of local memory 704a and to store a multiple results in a group of plurality of blocks of local memory 704b. The local memory interface 702 interfaces to each of the group-I of local memory blocks 704a and group-II of local memory blocks 704b of 16 kb local memory to independently transfer the data to each memory block included in the group-I 704a and group-II 704b and to independently receive the data from each memory block included in the group-I 704a and group-II 704b.

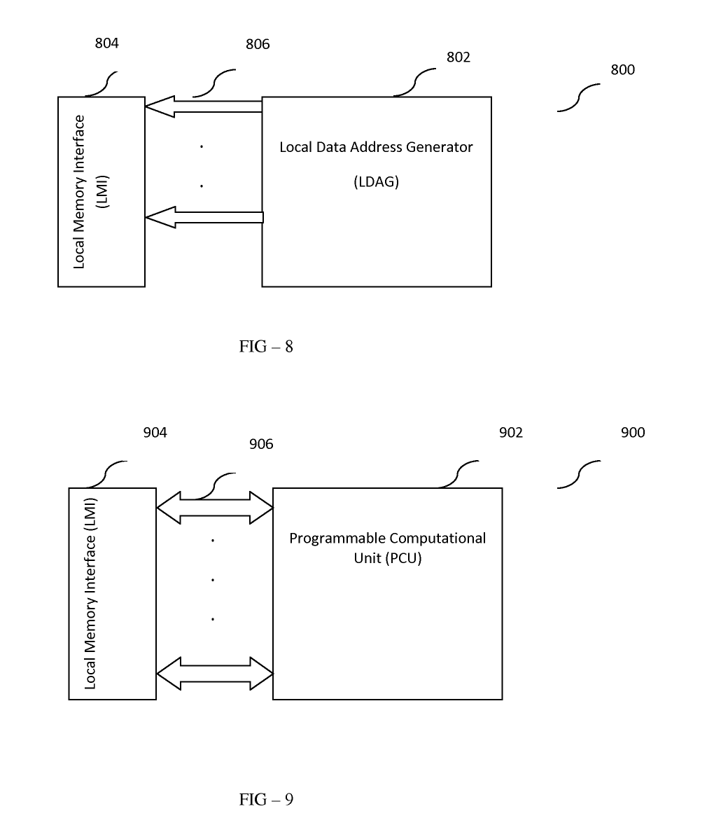

Referring to FIG. 8 is a diagram 800 depicting an overview of connectivity between local data address generator of a universal multifunction accelerator and a local memory interface. According to a non limiting exemplary embodiment of the present subject matter, the system includes a local data address generator 802 configured to communicate with a local memory interface 804 through a data bus 806.

In accordance with a non limiting exemplary implementation of the present subject matter, the local data address generator 802 computes a plurality of addresses of multiple operands to the local memory interface 804 through a data bus 806 where the plurality of address of multiple operands that are required to perform the operations specified by the instruction are computed by the local data address generator 802.

Referring to FIG. 9 is a diagram 900 depicting an overview of connectivity between programmable computational unit of a universal multifunction accelerator and a local memory interface. According to a non limiting exemplary embodiment of the present subject matter, the system includes a programmable computational unit 902 configured to communicate with a local memory interface 904 through a data bus 906.

In accordance with a non limiting exemplary implementation of the present subject matter, the programmable computational unit 902 configured in a universal multifunction accelerator performs a multiple computations specified by the plurality of instructions. The local memory interface 904 is configured to transfer multiple operands received from a plurality of local memory blocks to the programmable computation unit 902 through a data bus 906. The local memory interface 902 is also further configured to receive multiple results generated by the programmable computation unit 902 of a universal multifunction accelerator through a data bus 906.

Referring to FIG. 10 is a diagram 1000 depicting an overview of connectivity between system data address generator and system memory interface with a local memory interface. According to a non limiting exemplary embodiment of the present subject matter, the system includes a system data address generator 1002 and system memory interface 1004 which are configured to communicate with a local memory interface 1006 through an address data bus 1008 and data bus 1010.

In accordance with a non limiting exemplary implementation of the present subject matter, the system data address generator 1002 is configured to compute the address of location in the local memory corresponding to the address on the system bus. The system data address generator 1002 passes this local address to the local memory interface 1006 through the address bus 1008. The local memory interface 1006 interfaced to a multiple local memory blocks uses this address to store the data received from the system memory interface 1004 of a universal multifunction accelerator through a data bus 1010. In case the transfer for reading from the local memory by the system, the local memory interface 1006 transfers the data received from the local memory to the system memory interface 1004 through the data buss 1010. Thus the system data address generator 1002 facilitates all the local memory blocks interfacing with a local memory interface 1006 to appearing as a one unit of memory to the system bus by translating the system memory address to the local memory address.

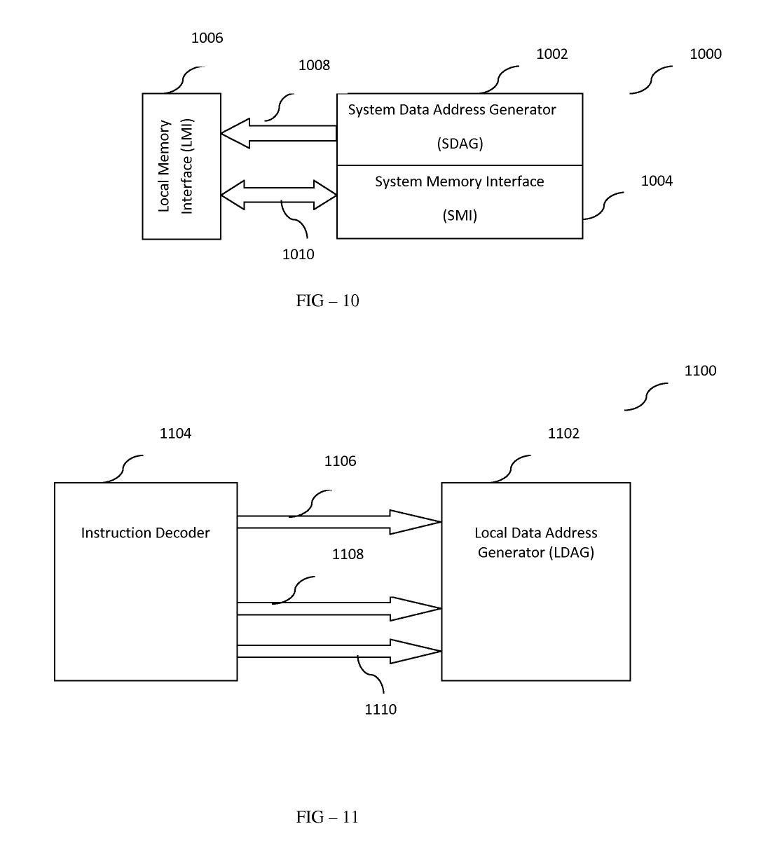

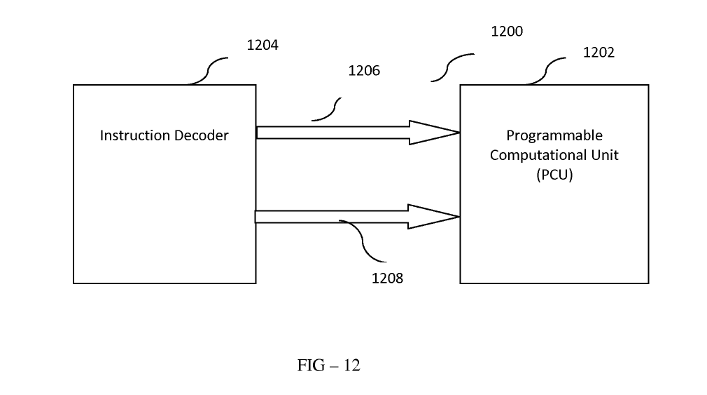

Referring to FIG. 11 is a diagram 1100 depicting an overview of connectivity between instruction decoder and a local data address generator. According to a non limiting exemplary embodiment of the present subject matter, the system includes an instruction decoder 1102 configured to communicate with a local data address generator 1104 through a control buses 1106 and 1110, through an address bus 1108.

In accordance with a non limiting exemplary implementation of the present subject matter, the universal multifunction accelerator is configured to perform middle stratum operations based on the operation code in the instruction. The Instruction decoder 1102 computes control signals and transfers the same to the local data address generator 1104 through a control bus 1106. The local data address generator 1104 computes the addresses of multiple operands and results needed for the instruction based on this control signal. The universal multifunction accelerator is further configured to transfer the initial address of the operand and the initial address of the result from the instruction decoder 1102 to the local data address generator 1104 through an address bus 1108. The local data address generator 1104 computes the addresses of multiple operands and results needed for the instruction based on these initial addresses. The instruction decoder is further configured to transfer mode signals based on the configuration parameter in the instruction by the instruction decoder 1102 to the local data address generator 1104 and programmable computational unit through a mode signal data bus 1110. The local data address generator 1104 computes the addresses of multiple operands and results needed for the instruction based on this mode signal.

Thus the local data address generator 1104 uses control signal corresponding to the operation code, the initial addresses of operands and results and mode signals corresponding to the configuration parameters.

According to a non limiting exemplary implementation, instruction corresponding to the computation of two radix operations, the addresses of multiple operands (addresses of four complex inputs and two complex twiddle factors) are computed by the local data address generator 1104. These addresses are spaced based on the size of the Fourier transform and the level in which the radix is being computed in the FFT (fast Fourier transform) algorithm. In a non limiting exemplary embodiment of this invention the values of the size and level of the FFT computation are placed in the configuration fields of the instruction.

Referring to FIG. 12 is a diagram 1200 depicting an overview of connectivity between instruction decoder and a programmable computation unit. According to a non limiting exemplary embodiment of the present subject matter, the system includes an instruction decoder 1202 configured to communicate with a programmable computation unit 1204 through a control busses 1206 and 1208.

In accordance with a non limiting exemplary implementation of the present subject matter, the programmable computational unit 1202 of the universal multifunction accelerator performs computations of multiple middle stratum operations which are a combination of both arithmetic and logical operations as specified by the instruction. The information regarding the type of middle stratum operations to be performed is obtained by the programmable computational unit 1202 through the control signals from the instruction decoder 1204. However the combination of computations to be performed for a given operation code (and hence the control signal) depends on the configuration parameters. The instruction decoder 1204 generates mode signals based on the configuration parameters and transfers the same to the programmable computational unit 1202 through the control bus 1208. A non limiting exemplary configuration parameter is the number of taps in a FIR filter, based on which the programmable computational unit 1202 is configured to perform required number of multiplications and additions.

While specific embodiments of the invention have been shown and described in detail to illustrate the inventive principles, it will be understood that the invention may be embodied otherwise without departing from such principles.

1. A system for processing middle stratum operations, comprising:
a processor for transmitting predesigned instructions of an application;
a system bus connected to said processor, said system bus configured to connect said processor to various components of said system;
a universal multifunction accelerator connected to said system bus, said system bus configured to connect said universal multifunction accelerator to various components of said system, said universal multifunction accelerator configured to receive said instructions;
a system memory configured to contain data of said application, said system memory connected to said universal multifunctional accelerator via said system bus; and
a local memory connected to said universal multifunction accelerator through a dedicated interface, said local memory configured to receive from said system memory said data and to store said data locally, said data being a dataset upon which said universal multifunction accelerator performs said middle stratum operations.

2. The system of claim 1, wherein said universal multifunction accelerator further comprising:
a system interface configured to receive said data with a system memory address from said system memory via said system bus;
a system data address generator configured to compute a local address, said local address being a location in said local memory corresponding to said system memory address received on said system bus;
a local memory interface (LMI) configured to store said data in said local memory in said local address location via a data bus;
a processor interface configured to receive said predesigned instructions of said application from said processor via a tightly coupled or a closely coupled port of said processor;
an instruction decoder configured to receive said instructions from said processor interface, said instruction decoder being further configured to decode said instructions and to generate a plurality of control signals for further use;
a local data address generator configured to receive some of said plurality of control signals from said instruction decoder via a plurality of control buses and a second address bus, said local data address generator further configured to determine a source data address containing said local address location of said data and a destination data address configured to store results of computation on said data, wherein said LMI configured to receive said source data address and destination data address from said local data address generator, said LMI further configured to access data in said local memory at said source address, and transfer said data to a programmable computational unit (PCU) for performing said middle stratum operations via a second data bus; and
said PCU configured to receive data from said LMI, said PCU further configured to receive some of said plurality of control signals from said instruction decoder, said PCU further configured to perform said middle stratum operations on said data, and produce said results, wherein said results are stored at said destination data address in said local memory via said LMI, wherein said system data address generator is further configured to receive a second system memory address where said results are to be stored, and thereafter compute a second local memory address corresponding to said destination data address, from where said results are accessed prior to being transferred to said system interface via said LMI, wherein said data corresponding to said results and said second system memory address eventually being transferred to said system memory via said system bus.

3. The system of claim 1, wherein said middle stratum operations comprise a combination of arithmetic and logical operations, and wherein said operations are specified in said predesigned instructions.

4. The system of claim 1, wherein said middle stratum operations comprises the parallel computation of two parallel Radix-2 operations.

5. The system of claim 1, wherein said middle stratum operations comprises the computation of one of FIR filter, radix operations, windowing functions, and quantization.

6. The system of claim 1, wherein said middle stratum operations are configured to operate in multimedia applications.

7. The system of claim 2, wherein said system interface is configured such that all local memory blocks in said local memory are visible as a single memory block to said system such that load or store direct memory access transfer operations are adequate to transfer data into and out of said local memory.

8. The system of claim 2, wherein said local memory interface is configured to store said data in several corresponding blocks of said local memory, and is configured to store said results in several corresponding blocks of said local memory.

9. The system of claim 2, wherein said instruction decoder is further configured to transfer mode signals based on configuration parameters in said predesigned instructions to said local data address generator and said programmable computational unit, through a mode signal data bus.

10. The system of claim 9, wherein said configuration parameters configure said combination of arithmetic and logical operations of said middle stratum operations such as a number of taps in a FIR filter, based on which said programmable computational unit is configured to perform required number of multiplications and additions.

11. A method for processing middle stratum operations, comprising:
transmitting predesigned instructions of an application via a processor;
connecting said processor to a universal multifunction accelerator;
receiving said instructions from said processor to said universal multifunction accelerator;
connecting a system memory and a local memory to said universal multifunctional accelerator, wherein said system memory is configured to contain data of said application, and wherein said local memory is configured to receive from said system memory said data in order to store said data locally; and
performing said middle stratum operations on said data, wherein said middle stratum operations being performed on said locally stored data by said universal multifunction accelerator.

12. The method of claim 11, further comprising:
receiving said data with a system memory address from said system memory via a system interface;
computing a local address for said data, said local address being computed by a system data address generator and said address being a location in said local memory corresponding to said system memory address;
storing said data in said local memory in said local address location, said storing being performed by a local memory interface (LMI) via a data bus;
receiving said predesigned instructions of said application from said processor through a processor interface, via a tightly coupled or a closely coupled port of said processor;
receiving said instructions from said processor interface, said instructions being received by an instruction decoder, said instruction decoder decoding said instructions and generating a plurality of control signals for further use;
receiving some of said plurality of control signals from said instruction decoder via a plurality of control buses and a second address bus by a local data address generator, said local data address generator determining a source data address containing said local address location of said data and a destination data address containing an address to store results of computation on said data;
receiving said source data address and destination data address from said local data address generator, said LMI performing said receiving step, said LMI thereafter accessing data in said local memory at said source address and transferring said data to a programmable computational unit (PCU) for performing said middle stratum operations via a second data bus;
receiving said data from said LMI by said PCU, said PCU further receiving some of said plurality of control signals from said instruction decoder, said PCU thereafter performing said middle stratum operations on said data, and producing said results;
storing said results at said destination data address in said local memory via said LMI;
receiving a second system memory address by said system data address generator where said results are eventually stored;
computing a second local memory address by said system data address generator, said second local memory address corresponding to said destination data address, and said second local memory address being a location in said local memory from where said results are accessed by said system data address generator;
transferring data corresponding to said results to said system interface via said LMI by said system address generator; and
transferring said data corresponding to said results and said system memory address to said system memory by said system interface.

13. The method of claim 11, wherein said middle stratum operations comprising a combination of arithmetic and logical operations, and specifying said operations in said predesigned instructions.

14. The method of claim 11, further comprising parallel computation of two parallel Radix-2 operations as part of said middle stratum operations.

15. The method of claim 11, further comprising computing of one of FIR filter, radix operations, windowing functions, and quantizationas part of said middle stratum operations.

16. The method of claim 11, further comprising operating middle stratum operations in multimedia applications.

17. The method of claim 12, further comprising making visible all local memory blocks in said local memory as a single memory block, such that load or store direct memory access transfer operations are adequate to transfer data into and out of said local memory.

18. The method of claim 12, further comprising configuring said local memory interface to store said data and results in several corresponding blocks of said local memory.

19. The method of claim 12, further comprising transferring mode signals based on configuration parameters in said predesigned instructions to said local data address generator and said programmable computational unit, through a mode signal data bus.

20. The method of claim 19, wherein said configuration parameters configuring said combination of arithmetic and logical operations of said middle stratum operations such as a number of taps in a FIR filter, based on which said programmable computational unit is configured to perform required number of multiplications and additions.
